(19) United States
(12) Patent Application Publication
(10) Pub. No.: US 2016/0283036 A1
(43) Pub. Date: Sep. 29, 2016

(54) DISPLAY DEVICE

(71) Applicant: Samsung Display Co., Ltd., Yongin-si (KR)

(72) Inventor: Jigong LEE, Cheonan-si (KR)

(21) Appl. No.: 15/069,261

(22) Filed: Mar. 14, 2016

(30) Foreign Application Priority Data
Mar. 26, 2015 (KR) 10-2015-0042398

(51) Int. Cl. G06F 3/041

(52) U.S. Cl. CPC G06F 3/0418; G06F 3/0412; G06F 2203/04102

(57) ABSTRACT

A display panel including pixels, each of the pixels including a display element, the display element including: a first electrode receiving a first voltage; a second electrode disposed on the first electrode and receiving a second voltage lower than the first voltage; and a light control layer disposed between the first and second electrodes; and a touch panel disposed on the display panel and including: a first touch electrode group; and a second touch electrode group disposed crossing the first touch electrode group, each including a plurality of touch electrodes, wherein one of the first touch electrode group and the second touch electrode group receives a scan signal having a first driving voltage level and a second driving voltage level; and wherein the second voltage has a voltage value substantially between the first driving voltage level and the second driving voltage level.

### CROSS-REFERENCE TO RELATED APPLICATION

This application claims priority from and the benefit of Korean Patent Application No. 10-2015-0042398, filed on Mar. 26, 2015, which is hereby incorporated by reference for all purposes as if fully set forth herein.

### BACKGROUND

1. Field

Exemplary embodiments relate to a display device. More particularly, exemplary embodiments relate to a display device including a touch panel.

2. Discussion of the Background

Various display devices are used for multimedia devices such as televisions, mobile phones, tablet computers, navigations, and game consoles. A keyboard or a mouse may is be included as an input device of a display device. Recently, display devices have included touch panels as input devices.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a display device capable of improving luminance by reducing a coupling phenomenon due to parasitic capacitance formed between a touch panel and a display panel.

Additional aspects will be set forth in the detailed description which follows, and, in part, will be apparent from the disclosure, or may be learned by practice of the inventive concept.

An exemplary embodiment discloses a display devices including: a display panel including a plurality of pixels, each of the plurality of pixels including a display element, the display element including: a first electrode configured to receive a first voltage; a second electrode disposed on the first electrode, the second electrode configured to receive a second voltage, the second voltage lower than the first voltage; and a light control layer disposed between the first and second electrodes. A touch panel disposed on the display panel, the touch panel including: a first touch electrode group; and a second touch electrode group disposed crossing the first touch electrode group, each of the first touch electrode group and the second touch electrode group including a plurality of touch electrodes. One of the first touch electrode group and the second touch electrode group is configured to receive a scan signal having a first driving voltage level and a second driving voltage level. The second voltage has a voltage value substantially between the first driving voltage level and the second driving voltage level.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIGS. 1A and 1B are perspective views of a flexible display device according to an exemplary embodiment.

FIGS. 2A, 2B, and 2C are sectional views of a flexible display device according to an exemplary embodiment taken along a first direction axis.

FIG. 3 is a sectional view of a touch panel according to an exemplary embodiment.

FIG. 4 is a block diagram illustrating a display device according to an exemplary embodiment.

FIG. 5 is a circuit diagram illustrating a pixel structure shown in FIG. 4.

FIG. 6 is a sectional view of a display panel and a touch panel according to an exemplary embodiment.

FIG. 7 is a plan view of a touch panel according to an exemplary embodiment.

FIG. 8 is a timing diagram illustrating a driving voltage provided to a conventional touch panel and display panel according to the prior art.

FIG. 9 is a timing diagram illustrating a driving voltage provided to a touch panel and a display panel according to an exemplary embodiment.

FIG. 10 is a timing diagram illustrating a driving voltage provided to a touch panel and a display panel according to an exemplary embodiment.

FIG. 11 is a graph illustrating characteristics of a light emission transistor included in a pixel shown in FIG. 5.

FIG. 12 is a graph illustrating luminance of a display panel according to an intensity of driving current.

FIG. 13 is a timing diagram illustrating a driving voltage provided to a touch panel and a display panel according to an exemplary embodiment.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

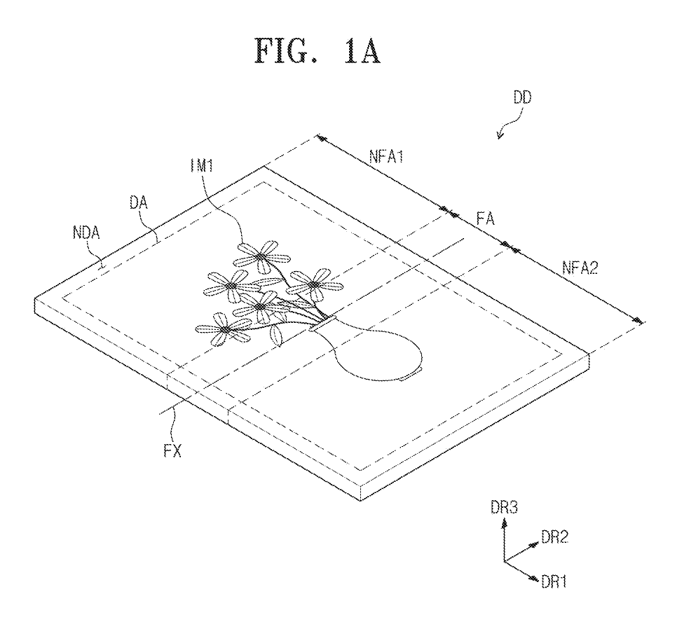

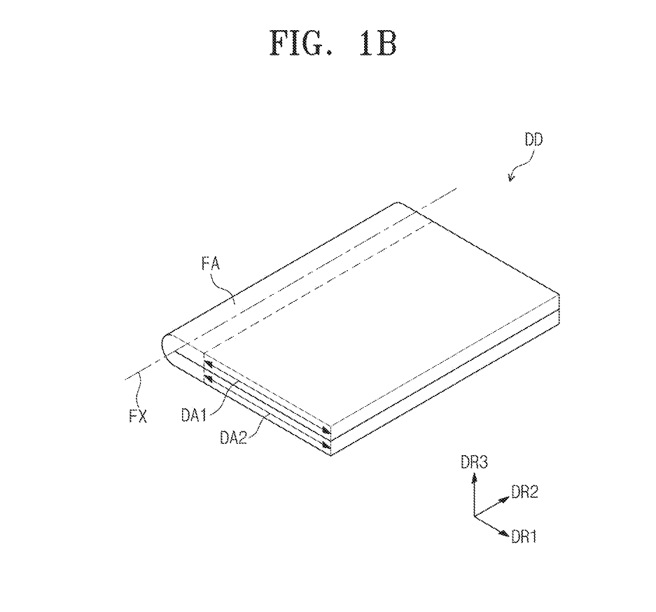

FIGS. 1A and 1B are perspective views of a flexible display device DD according to an exemplary embodiment. According to the exemplary embodiment, the flexible display device DD is illustrated to be a foldable display device (hereinafter referred to as a display device). However, the exemplary embodiments are not limited thereto, and the flexible display device DD may have various display device forms including curved display devices, bending type display devices, rollable display devices, and stretchable display devices. Furthermore, the display device DD may be used for small and medium-sized electronic devices including mobile phones, personal computers, notebook computers, personal digital assistants, vehicle navigation devices, game consoles, portable electronic devices, wrist watch type electronic devices, and cameras as well as for large-sized electronic devices such as televisions or outdoor advertisement boards.

Referring to FIGS. 1A and 1B, a display surface is configured to display an image IM1, and is disposed parallel to a surface defined by a first direction axis DR1 and a second direction axis DR2. A third direction axis DR3 indicates a normal direction of the display surface, and the third direction axis DR3 indicates a thickness direction of the flexible display device DD. Elements of the display device DD may have a front surface facing in a positive direction of the third direction axis DR3 and a rear surface facing a negative direction of the third direction axis DR3. However, directions of the first, second and third direction axes DR1, DR2, and DR3 are relative, and therefore, may be interchangeable with other directions.

Referring to FIG. 1, the display device DD includes the display surface including a display area DA and a non display area NDA, depending on where the image is displayed. The display area DA may be an area configured to display an image, and the non display area NDA disposed adjacent to the display area DA, which is configured not to display any image. FIG. 1 illustrates a vase image as an example of the image IM1. According to the exemplary embodiment, the display area DA may have a rectangular shape. The non display area NDA may be disposed surrounding the display area DA. The display device DD may include a folding area FA that may be folded along the folding axis FX, a first non folding area NFA, and a second non folding area NFA.

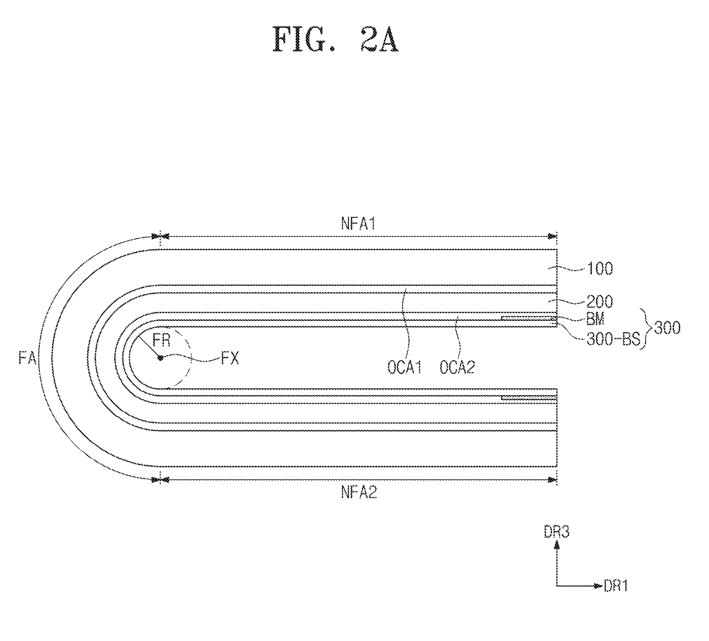

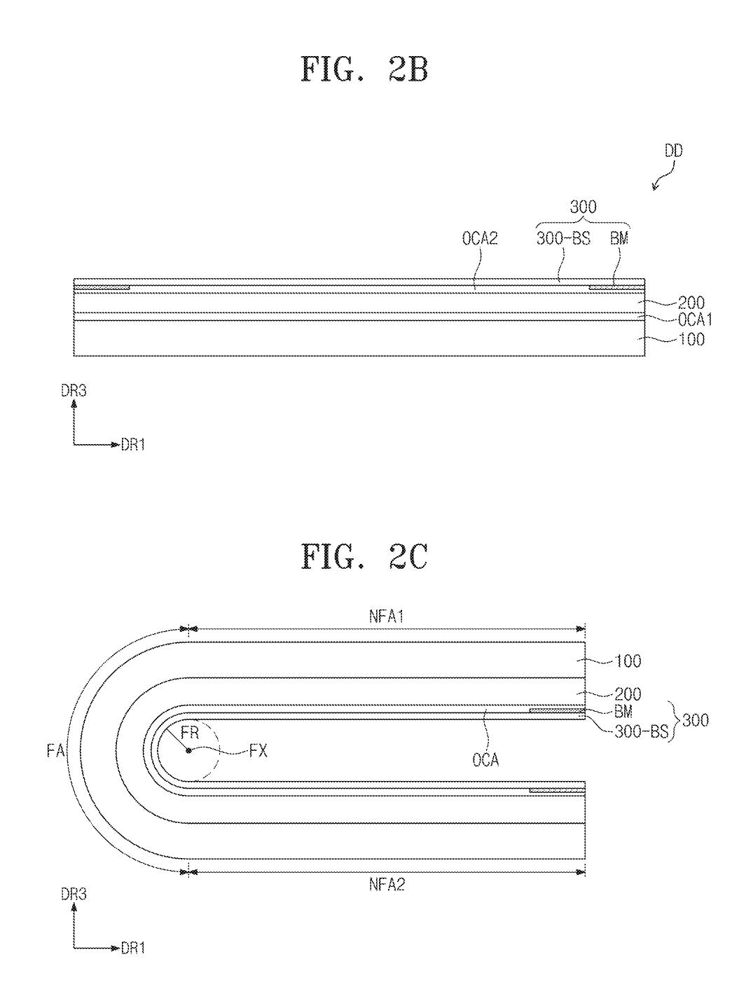

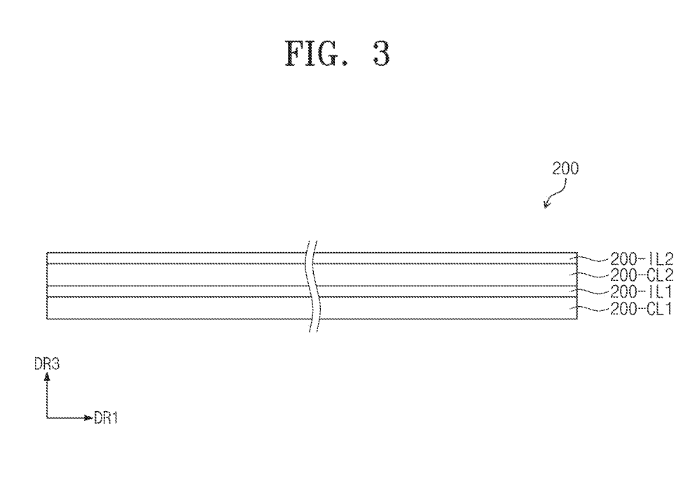

FIGS. 2A and 2B are enlarged sectional views of the display device DD according to an exemplary embodiment. Referring to FIG. 2A, the display device DD may be folded along the folding axis FX so that the display surface of the first non folding area NFA1 and the display surface of the second non folding area NFA2 may face each other. Hereinafter, folding the display device DD so that the display surfaces of different areas may face each other is defined as an inner folding. According to the exemplary embodiment, the first non folding area NFA1 rotates clockwise along the folding axis FX to perform an inner folding of the display device DD. The display device DD may also be folded along the folding axis FX so that the display surface of the first non folding area NFA1 and the display surface of the second non folding area NFA2 may face away from each other. Hereinafter, folding the display device DD so that the display surfaces of different areas may face away from each other is defined as outer folding.

Referring to FIGS. 2A, 2B, and 2C, the display device DD may include a display panel 100, a touch panel 200, and a window member 300. The display device DD may further include a protection member (not shown) coupled to the window member 300 to protect the display panel 100 and the touch panel 200. Each of the display panel 100, the touch panel 200, and the window member 300 may have a flexible property.

The display panel 100 may generate the image IM1 (refer back to FIG. 1A) corresponding to received image data. The display panel 100 may include, but is not limited to, a liquid crystal display panel, an organic light emitting display panel, an electrophoretic display panel, and an electrowetting display panel. According to an exemplary embodiment, the display panel 100 includes an organic light emitting display panel.

The touch panel 200 may detect the coordinate information of a location of a touch input. The touch panel 200 may be disposed on the front surface of the display panel 100. However, the exemplary embodiments are not limited thereto, and the display panel 100 and the touch panel 200 may have a different position relationship. The touch panel 200 may be a contact type or non-contact type touch panel.

The window member 300 may include a base member 300-BS and a black matrix BM. The black matrix BM is disposed at the rear surface of the base member 300-BS, and define a bezel area of the display device DD, that is, the non display area NDA (see FIG. 1A). The base member 300-BS may include, but not limited to, a glass substrate, a sapphire substrate, a plastic film, and so on. The black matrix BM may be a colored organic layer formed through a coating method. The window member 300 may further include a functional coating layer (not shown) disposed on the front surface of the base member 300-BS. The functional coating layer may include an anti-fingerprint layer (not shown), anti-reflective layer (not shown), and a hard coating layer (not shown).

The display panel 100 and the touch panel 200 may be coupled to each other by a first Optically Clear Adhesive film OCA1. The touch panel 200 and the window member 300 may be also coupled to each other by a second Optically Clear Adhesive film OCA2.

According to an exemplary embodiment, the touch panel 200 shown in FIG. 2A and FIG. 2B may be an Add-on type, in which the touch panel 200 is coupled to the display panel 100 by the optically clear Adhesive film OCA1.

According to an exemplary embodiment, the touch panel 200 shown in FIG. 2C may be an On-cell type, in which the touch panel 200 is directly patterned on the display panel 100. In this case, the first Optically Clear Adhesive film OCA1 may be omitted.

According to the exemplary embodiment, the touch panel 200 is described to be the On-cell type for explanation purpose. However, the exemplary embodiments are not limited thereto, and the touch panel 200 may be an In-cell type.

FIG. 3 is a sectional view of the touch panel 200 according to an exemplary embodiment. Referring to FIG. 3, the touch panel 200 may include a first conductive layer 200-CL1, a first insulation layer 200-IL1, a second conductive layer 200-CL2, and a second insulation layer 200-IL2. According to the exemplary embodiment, the first conductive layer 200-CL1, the first insulation layer 200-IL1, the second conductive layer 200-CL2, and the second insulation layer 200-IL2 may be sequentially stacked on the display panel 100 (refer back to FIG. 2B). The Optical Clear Adhesive film OCA as shown in FIG. 2C is omitted for explanation purpose.

The first conductive layer 200-CL1 may include at least one of indium tin oxide (ITO), indium zinc oxide (IZO), zinc oxide (ZnO), and indium tin zinc oxide (ITZO). The first conductive layer 200-CL1 may include a metal including at least one of molybdenum, silver, titanium, copper, aluminum, and an alloy thereof. The first conductive layer 200-CL1 may also include at least one of PEDOT, metal nanowire, and graphene.

The first conductive layer 200-CL1 may include at least two layers including a first layer including one of the above-mentioned materials, a second layer including another one, and other layers. The first conductive layer 200-CL1 may include at least two first conductive patterns disposed on the display panel 100. The first conductive patterns may include touch sensors and signal lines. Touch sensors and/or signal lines may include conductive lines. The conductive lines may be formed by patterning the first conductive layer 200-CL1 through a photolithography process.

The first insulation layer 200-IL1 may protect the first conductive patterns of the first conductive layer 200-CL1 and/or insulate some of the first conductive patterns from other first conductive patterns. The first insulation layer 200-IL1 may include an inorganic layer and/or an organic layer. The first insulation layer 200-IL1 may have a multilayer structure and may include at least one inorganic layer and at least one organic layer.

The second conductive layer 200-CL2 may include a transparent conductive oxide. The second conductive layer 200-CL2 may have a single layer or multilayer structure. The second conductive layer 200-CL2 may include second conductive patterns.

The second insulation layer 200-IL2 may protect the second conductive layer 200-CL2. The second insulation layer 200-IL2 may include an inorganic layer and/or an organic layer. The second insulation layer 200-IL2 may have a multilayer structure and may include at least one inorganic layer and at least one organic layer. According to an exemplary embodiment, the second insulation layer 200-IL2 may be omitted. According to an exemplary embodiment, the positions of the first conductive layer 200-CL1 and the second conductive layer 200-CL2 may be interchanged.

Moreover, the touch panel 200 may further include a base member (not shown). In this case, the first conductive layer 200-CL1, the first insulation layer 200-IL1, the second conductive layer 200-CL2, and the second insulation layer 200-IL2 may be sequentially stacked on the base member (not shown). the base member may be disposed on a sealing layer or a sealing substrate of the display panel. According to an exemplary embodiment, the first conductive layer 200-CL1 (see FIG. 3) of the touch panel 200 may be directly disposed on the sealing layer or the sealing substrate of the display panel.

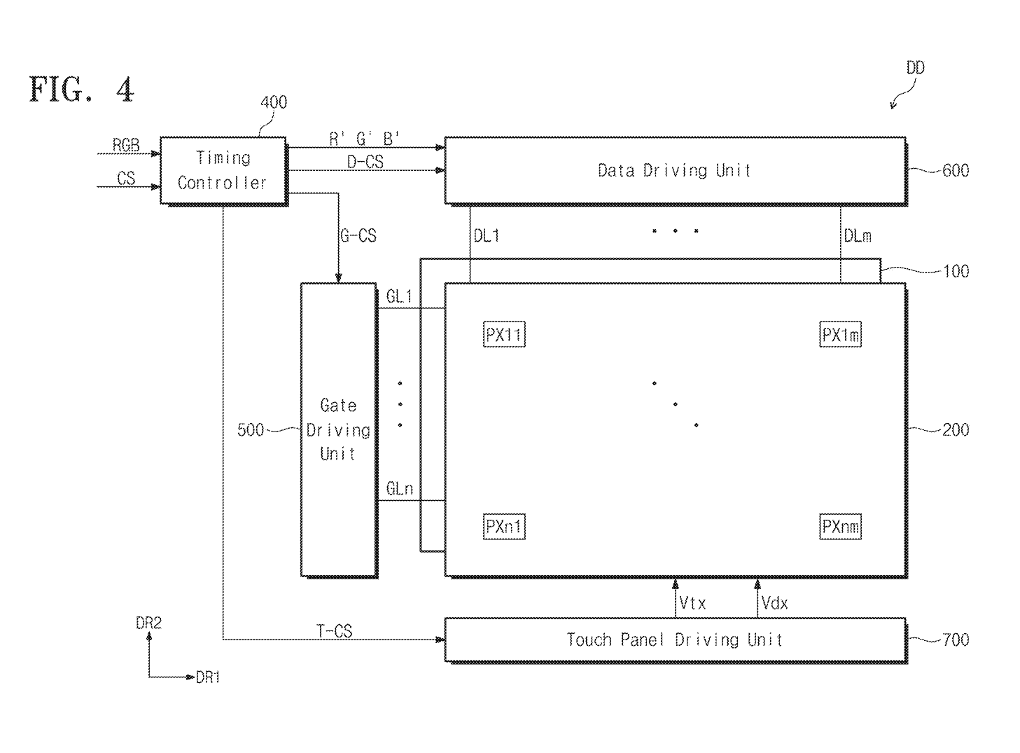

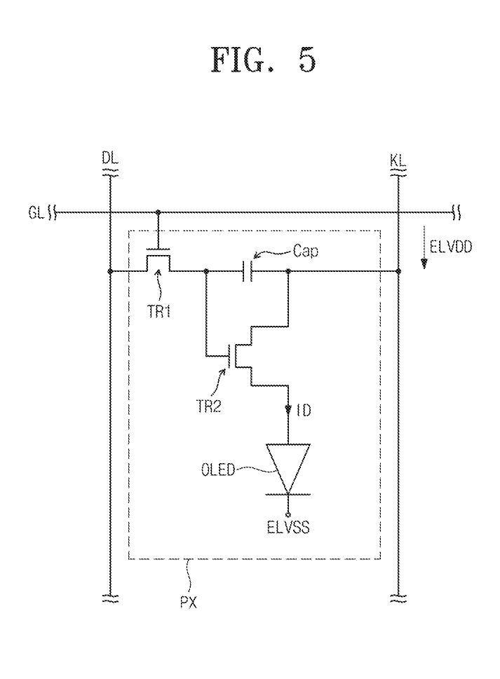

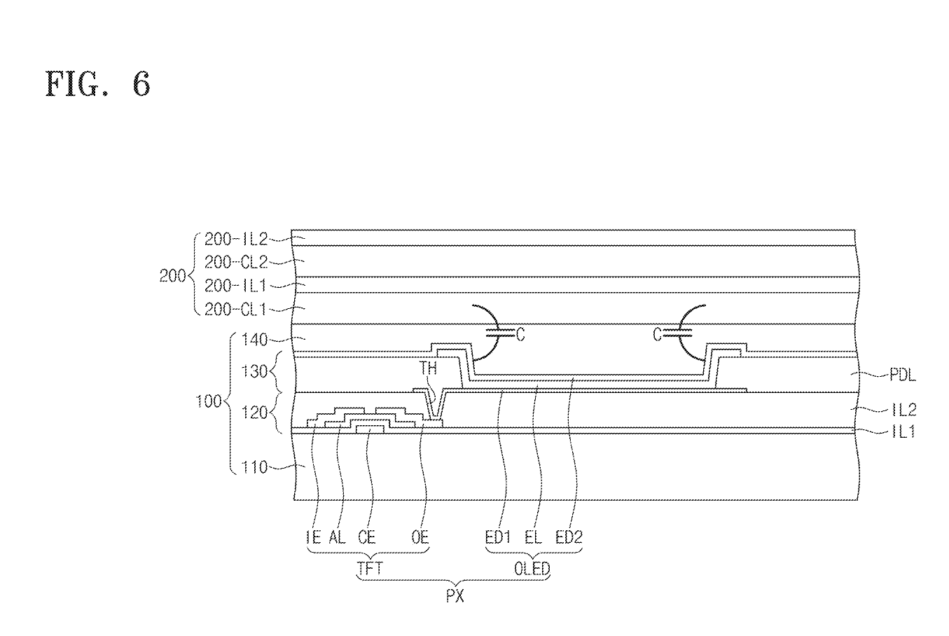

FIG. 4 is a block diagram illustrating a display device according to an exemplary embodiment. FIG. 5 is a circuit diagram illustrating a pixel structure shown in FIG. 4 according to an exemplary embodiment. FIG. 6 is a sectional view of the touch panel and the display panel shown in FIG. 4 according to an exemplary embodiment.

Referring to FIG. 4, a display device DD includes a display panel 100, a touch panel 200, a timing controller 400, a gate driving unit 500, a data driving unit 600, and a touch panel driving unit 700. The timing controller 400, the gate driving unit 500, the data driving unit 600, and the touch panel driving unit 700 are configured to control the display panel 100 to display an image. The display device DD may further include a touch detection unit (not shown) to detect coordinate information of the touched location on the touch panel 200.

According to an exemplary embodiment, the display panel 100 may include a liquid crystal display panel, an organic light emitting display panel, an electrophoretic display panel, and an electrowetting display panel. According to the exemplary embodiment, the display panel 100 is an organic light emitting display panel for explanation purposes. The display device DD may further include a backlight unit (not shown) for providing light to the display panel 100 when the display device DD includes the liquid crystal display panel. The display device DD may further include one pair of polarizing plates (not shown).

The display panel 100 may include gate lines GL1 to GLn, data lines DL1 to DLm, and pixels PX11 to PXnm. The gate lines GL1 to GLn extend in the direction along the first direction axis DR1 and are arranged in the direction along the second direction axis DR2. The data lines DL1 to DLm and the gate lines GL1 to GLn are disposed crossing each other being insulated from each other. The gate lines GL1 to GLn are connected to the gate driving unit 500 and the data lines DL1 to DLm are connected to the data driving unit 600.

The pixels PX11 to PXmn are arranged in a matrix. The pixels PX11 to PXnm are connected to respective gate line among the plurality of gate lines GL1 to GLn and respective data line among the plurality of data lines DL1 to DLm.

The touch panel 200 may be disposed on the display panel 100, and may operate in a capacitive manner, an electromagnetic induction manner, or a hybrid manner, in response to driving voltages Vtx and Vdx transmitted from the touch panel driving unit 700. According to an exemplary embodiment, the touch panel 200 operates in a capacitive manner, but the exemplary embodiments are not limited thereto, and therefore, the touch panel 200 may operate in an electromagnetic induction manner mode or a hybrid manner mode. Also, the touch panel 200 may be any type which includes two sensors disposed crossing each other.

The timing controller 400 may receive image signals RGB from external device and may convert the image signals RGB into image data R′G′B′ corresponding to an operating mode of the display panel 100. The timing controller 400 may also receive various control signals CS which includes, for example, a vertical sync signal, a horizontal sync signal, a main clock signal, and a data enable signal, and transmits a gate control signal G-CS, a data control signal D-CS, and a touch driving signal T-CS.

The gate driving unit 500 may output a plurality of gate signals to the plurality of gate lines GL1 to GLn in response to the gate control signal G-CS. The gate control signal G-CS may include a vertical start signal for starting an operation of the gate driving unit 500, a gate clock signal for determining an transmission timing of a gate voltage, and an output enable signal for determining an on-pulse width of a gate voltage.

The data driving unit 600 may receive the data control signal D-CS and the image data R′G′B′. The data driving unit 600 may convert the image data R′G′B′ into data voltages and may provide them to the plurality of data lines DL1 to DLm. The data control signal D-CS includes a horizontal start signal for staring an operation of the data driving unit 600, a conversion signal for converting the plurality of data voltages, and an output indication signal for determining the timing the data voltages are transmitted from the data driving unit 600.

The touch panel driving unit 700 receives a touch driving signal T-CS from the timing controller 400. In response to the received touch driving signal T-CS, the touch panel driving unit 700 transmits a scan signal Vtx and a detection voltage Vdx for driving the touch panel 200. For example, the scan signal Vtx may be sequentially or simultaneously transmitted to a plurality of touch electrodes disposed in the touch panel 200.

Referring to FIG. 5 and FIG. 6, each of the gate lines GL1 to GLn and the data lines DL1 to DLm are connected to a corresponding pixel PX among the plurality of pixels PX11 to PXnm. The pixel PX may include a driving transistor TR1, a light emission transistor TR2, at least one capacitor Cap, and an organic light emitting device OLED.

The display panel 100 may include a base substrate 110, a device layer 120, a display layer 130, and a thin film sealing layer 140, which are sequentially stacked. The pixel PX may include a thin film transistor TFT and an organic light emitting device OLED. The thin film transistor TFT corresponds to the above-mentioned driving transistor TR1 as described with reference to FIG. 5.

The base substrate 110 may be a glass substrate, a plastic substrate, and/or a film. The base substrate 110 may support the display panel 100.

The device layer 120 may include a thin film transistor TFT, a first insulation layer IL1 and a second insulation layer IL2. Specifically, the thin film transistor TFT may include a control electrode CE, a semiconductor layer AL, an input electrode IE, and an output electrode OE. The control electrode CE may be disposed on the base substrate 110. The control electrode CE may be electrically connected to a corresponding gate line of the plurality of gate lines GL1 to GLn.

The first insulation layer IL1 may be disposed on the control electrode CE. The first insulation layer IL1 may cover the control electrode CE and the corresponding gate line.

The semiconductor layer AL may be disposed on the first insulation layer IL1. The semiconductor layer AL overlaps the control electrode CE. The input electrode IE and the output electrode OE may be disposed on the first insulation layer IL1 spaced from each other. A corresponding data lines of plurality of data lines DL1 to DLm may be disposed on the first insulation layer IL1. The input electrode IE may be electrically connected to the corresponding data line.

The second insulation layer IL2 may be disposed on the first insulation layer IL1 to cover the thin film transistor TFT. The second insulation layer IL2 may electrically insulate the thin film transistor TFT from other components.

The display layer 130 may be disposed on the device layer 120. The display layer 130 may include an organic light emitting device OLED and a pixel definition layer PDL. The organic light emitting device OLED may include a first electrode ED1, an organic layer EL, and a second electrode ED2.

The first electrode ED1 may be disposed on the second insulation layer IL2. The first electrode ED1 may be connected to the output electrode OE via a through hole TH formed penetrating through the second insulation layer IL2. Herein, the first electrode ED1 may be an anode electrode and may receive a first voltage ELVDD from a power line KL. For example, the anode electrode may receive a voltage of a positive polarity.

The pixel definition layer PDL may be disposed on the second insulation layer IL2. The pixel definition layer PDL may include at least one of an organic material and an inorganic material. The organic layer EL may be disposed on the first electrode ED1. The organic layer EL may include a light control layer for generating light when an electrical signal is applied.

The second electrode ED2 may be disposed on the organic layer EL and the pixel definition layer PDL. The second electrode ED2 may be disposed on the front surface of the display layer 130. The second electrode ED2 may be a cathode electrode and may receive a second voltage ELVSS. For example, the cathode electrode may receive a negative voltage.

According to the exemplary embodiments, each of the first voltage ELVDD and the second voltage ELVSS may include a Direct Current (DC) component.

A sealing layer 140 may be disposed on the second electrode ED2.

According to the exemplary embodiment, the first conductive layer 200-CL1, the first insulation layer 200-IL1, the second conductive layer 200-CL2, and the second insulation layer 200-IL2 may be sequentially stacked on the display panel 100 (refer back to FIG. 2B).

According to the exemplary embodiment shows that the display layer 130 includes the organic light emitting device OLED and the pixel definition layer PDL, the exemplary embodiments are not limited thereto. The display layer 130 may include a liquid crystal layer, a pixel electrode, and a common electrode. That is, the display layer 130 may be a liquid crystal display device.

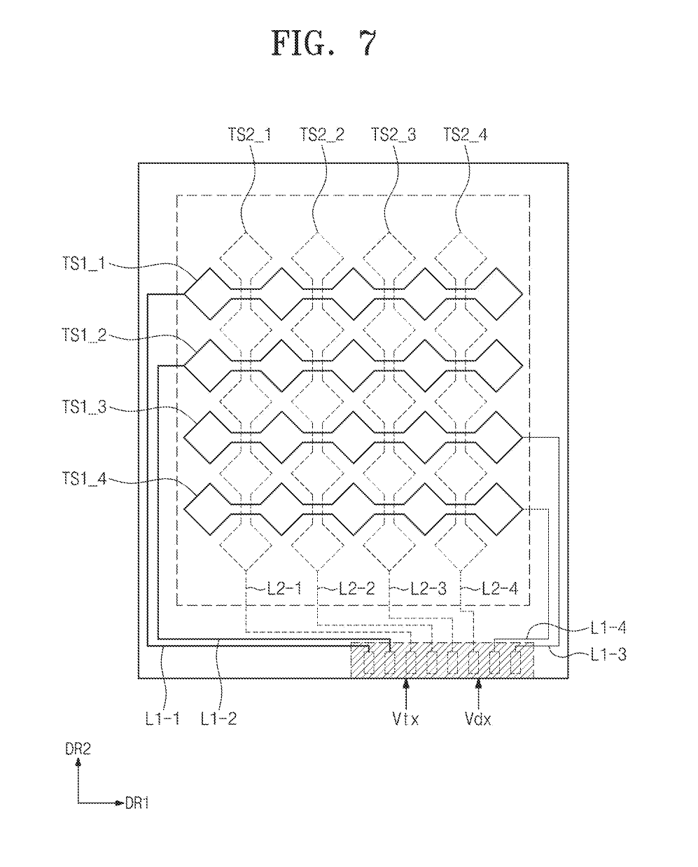

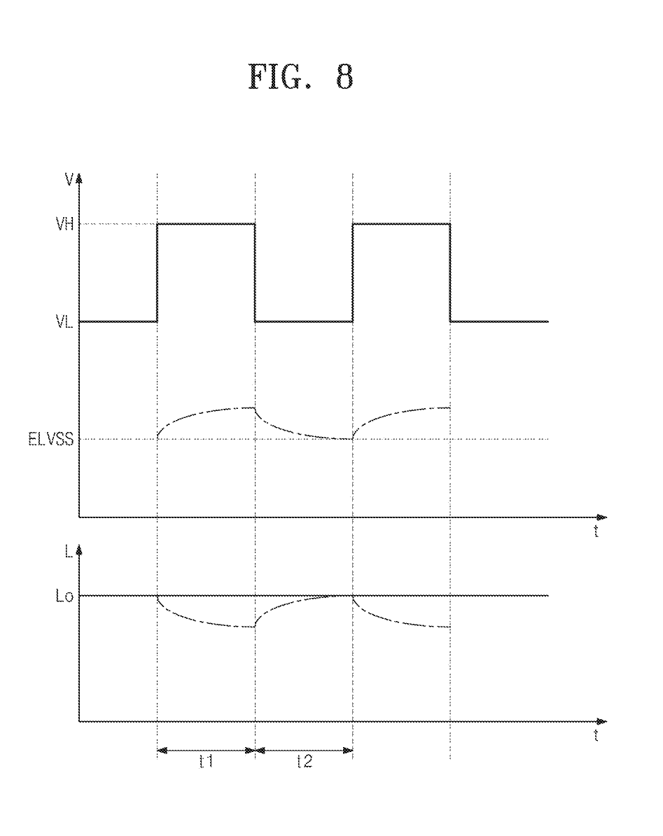

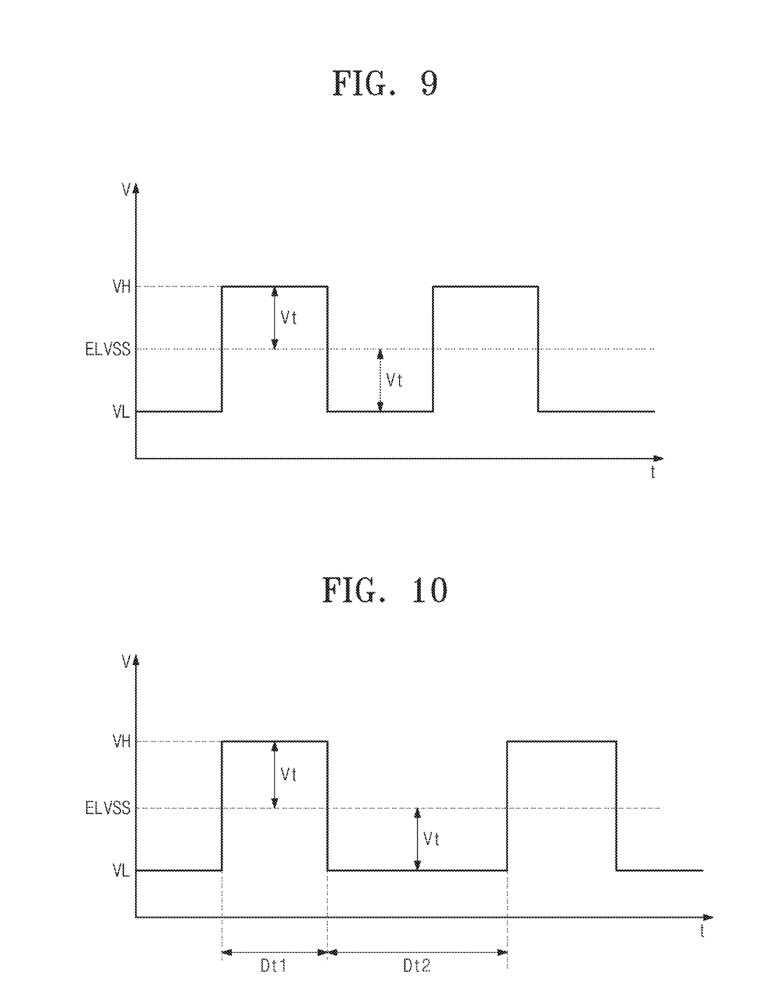

FIG. 7 is a plan view of a touch panel according to an exemplary embodiment. FIG. 8 is a timing diagram illustrating a driving voltage provided to a conventional touch panel and display panel. FIG. 9 is a timing diagram illustrating a driving voltage provided to a touch panel and a display panel according to an exemplary embodiment.

Referring to FIG. 7, each of a first conductive layer 200-CL1 and a second conductive layer 200-CL2 may include at least one transparent conductive layer and at least one metal layer, which are stacked along the direction of the third direction axis DR3. The first conductive layer 200-CL1 may include a plurality of first touch electrodes TS1_1 to TS1_4 (hereinafter collectively referred to as a first touch electrodes TS1) and a plurality of first signal lines L1_1 to L1_4 (hereinafter collectively referred to as a first signal lines L1). The first touch electrodes TS1 may receive a scan signal Vtx through the first signal lines L1. The second conductive layer 200-CL2 may include a plurality of second touch electrodes TS2_1 to TS2_4 (hereinafter collectively referred to as a second touch electrodes TS2) and a plurality of second signal lines L2_1 to L2_4 (hereinafter collectively referred to as a second signal lines L2). The second touch electrodes TS2 may receive a detection voltage Vdx through the second signal lines L2.

According to an exemplary embodiment, the first touch electrodes TS1 may sequentially receive a scan signal Vtx. According to an exemplary embodiment, the first touch electrodes TS1 may also receive a scan signal Vtx simultaneously.

According to an exemplary embodiment, the touch panel 200 (refer back to FIG. 6) may detect the coordinate information of the touched location based on a mutual capacitance method or a self capacitance method.

Conventionally, a parasitic capacitance may form from coupling between electrodes having different voltages. For example, referring to FIG. 6, a parasite capacitance C may form between the second electrode ED2 and the first conductive layer 200-CL1. That is, as the scan signal VTx is transmitted to the first touch electrodes TS1 disposed in the first conductive layer 200-CL1, a voltage level of the second electrode ED2 may change. Due to such coupling between the second electrode ED2 and the first conductive layer 200-CL, the image quality of the display device DD may be distorted.

Referring to FIG. 8, a horizontal axis represents time t and a vertical axis represents the intensity and luminance L of voltage V. The scan signal Vtx may be a driving pulse signal having a first driving voltage level VH and a second driving voltage level VL. The first driving voltage level VH may be higher than the second driving voltage level VL. The second driving voltage level VL may be higher than the second voltage ELVSS provided to the second electrode ED2.

At the first time interval t1, the second driving voltage level VL is shifted to the first driving voltage level VH. The first touch electrodes TS1 may receive a scan signal Vtx of the first driving voltage level VH. In this case, due to a coupling between the second electrode ED2 and the first touch electrodes TS1, a level of the second voltage ELVSS may increase. As the level of the second voltage ELVSS rises, the luminance Lo is reduced.

At the second time interval t2, the first driving voltage level VH is shifted to the second driving voltage level VL. The first touch electrodes TS1 may receive a scan signal Vtx of the second driving voltage level VL. In this case, due to a coupling between the second electrode ED2 and the first touch electrodes TS1, a level of the second voltage ELVSS may decrease. As the level of the second voltage ELVSS drops, the luminance Lo is increased.

Referring to FIG. 9, according to an exemplary embodiment, the second voltage ELVSS may have a voltage value between the first driving voltage level VH and the second driving voltage level VL. For example, the first driving voltage level VH may be a positive voltage and the second driving voltage level VL may be a negative voltage. However, the exemplary embodiments are not limited thereto, and the first and second driving voltage levels VH and VL may have variously value.

Specifically, the second voltage ELVSS may be substantially an average value of the first driving voltage level VH and the second driving voltage level VL. As a result, a voltage difference Vt between the level of the second voltage ELVSS and the first driving voltage level VH may be identical to a voltage difference Vt between the level of the second voltage ELVSS and the second driving voltage level VL.

The first time interval t1 during which the first driving voltage level VH is applied may be identical to the second time interval t2 during which the second driving voltage level VL. That is, the touch panel driving unit 700 (refer back to FIG. 1) may transmit the scan signal Vtx having the first driving voltage level VH and the second driving voltage level VL at the same duty ratio.

According to the exemplary embodiment, since the second voltage ELVSS may be an average value of the first driving voltage level VH and the second driving voltage level VL, a coupling phenomenon between the second electrode ED2 and the first conductive layer 200-CL may be reduced. As a result, the image quality distortion of the display panel 100 due to coupling may be prevented.

FIG. 10 is a timing diagram illustrating a driving voltage provided to a touch panel and a display panel according to an exemplary embodiment. Referring to FIG. 10, a second voltage ELVSS may have a voltage value between a first driving voltage level VH and a second driving voltage level VL. That is, the second voltage ELVSS shown in FIG. 10 may be identical to the second voltage ELVSS described above with reference to FIG. 9. Accordingly, detailed description of the second voltage ELVSS will be omitted.

According to an exemplary embodiment, the touch panel driving unit 700 (refer back to FIG. 4) may transmit a scan signal Vtx having the first driving voltage level VH and the second driving voltage level VL having different duty ratios from each other. That is, the length of the first time interval Dt1 having the first driving voltage level VH may be different from the length of the second time interval Dt2 having the second driving voltage level VL. Accordingly, the second time interval Dt2 having the second driving voltage level VL may be transmitted for longer time than the first time interval Dt1 having the first driving voltage level VH.

In such a way, when the second time interval Dt2 may be set longer than the first time interval Dt1, the variation of the driving current ID provided to the organic light emitting device OLED may be reduced. As a result, the change of an overall luminance of the display device DD may be reduced.

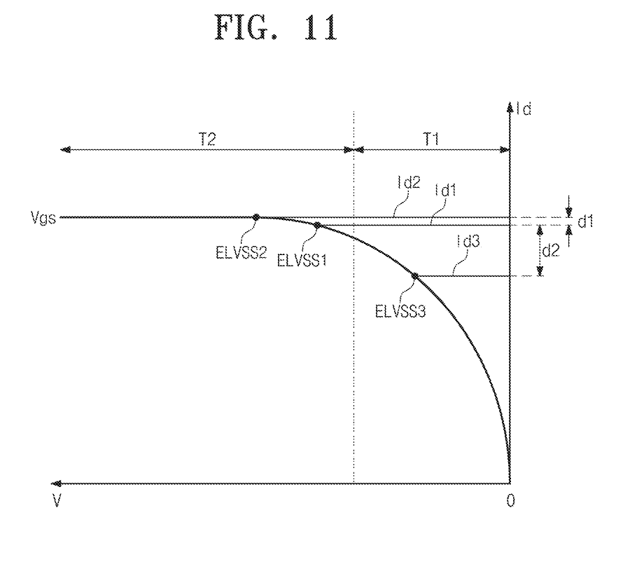

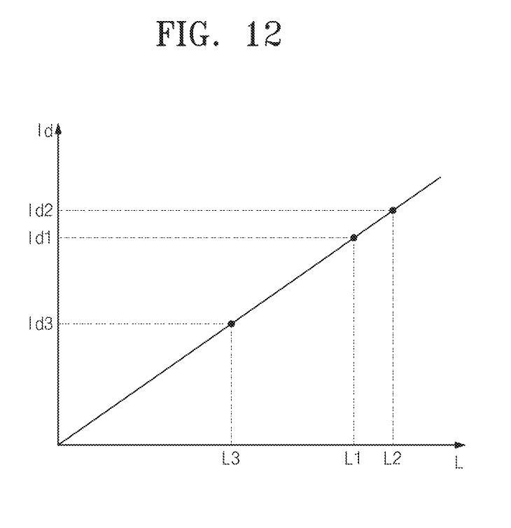

FIG. 11 is a view illustrating characteristics of a light emission transistor included in a pixel shown in FIG. 5. FIG. 12 is a graph illustrating luminance information of a display panel according to an intensity of driving current.

According to the description, a driving transistor TR1 and a light emission transistor TR2 included in a pixel PX may be configured with a PMOS transistor. Specifically, referring to FIGS. 11 and 12, as the level of the second voltage ELVSS is changed, a value of a driving current Id provided to the organic light emitting device OLED shown in FIG. 5 may change. That is, the organic light emitting device OLED may operate according to the second voltage ELVSS and a value of the driving current Id corresponding to the second voltage ELVSS.

For example, a coupling between the second electrode ED2 and the first touch electrodes TS1 may reduce the second voltage ELVSS from the first voltage level ELVSS1 to the second voltage level ELVSS2. In this case, the driving current Id may rise from the first current level Id1 to the second current level Id2. As a result, as shown in FIG. 12, the luminance L may be increased from the first level L1 to the second level L2. A discrepancy between the first current level Id1 and the second current level Id2 may be defined as a first current size d1.

For example, a coupling between the second electrode ED2 and the first touch electrodes TS1 may increase the second voltage ELVSS from the first voltage level ELVSS1 to the third voltage level ELVSS3. In this case, the driving current Id may drop from the first current level Id1 to the third current level Id3. As a result, as shown in FIG. 12, the luminance L may be deceased from the first level L1 to the third level L3. A discrepancy between the first current level Id1 and the third current level Id3 may be defined as a second current size d2.

The first time interval T1 may be a linear region and the second time interval T2 may be a saturation region. The driving current Id may have larger variation in the linear region than the saturation region. That is, if the second voltage ELVSS continuously decreases, the driving current Id may decrease greatly according to characteristics of a linear area. As a result, the discrepancy in luminance of the display device DD may be greater between the first level L1 and the third level L3 than between the first level L1 and the second level L2.

As the level of the second voltage ELVSS increases, the driving current Id provided to the organic light emitting device OLED may decrease. As a result, the overall luminance of the display panel 100 may decrease.

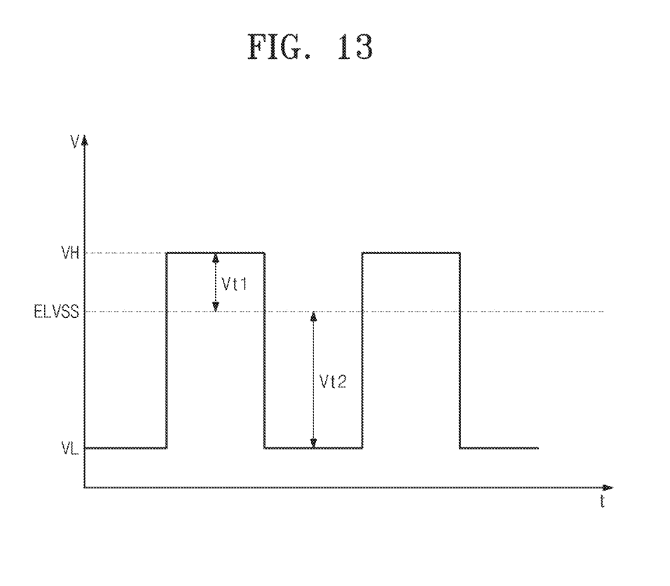

FIG. 13 is a timing diagram illustrating a driving voltage provided to a touch panel and a display panel according to an exemplary embodiment. Referring to FIG. 13, a second voltage ELVSS may have a voltage value between a first driving voltage level VH and a second driving voltage level VL. Specifically, a first voltage difference Vt1 between the level of the second voltage ELVSS and the first driving voltage level VH may be different from a second voltage difference Vt2 between the level of the second voltage ELVSS and the second driving voltage level VL. Especially, the second size difference Vt2 may be greater than the first size difference Vt1.

As the first size difference Vt1 may increases, the level of the second voltage ELVSS may decrease. As a result, the driving current Id provided to the organic light emitting device OLED may decrease drastically, and therefore, the luminance may be reduced. Accordingly, referring to FIG. 13, the touch panel driving unit 700 (refer back to FIG. 4) according to the exemplary embodiment may transmit a scan signal Vtx having the second voltage difference Vt2 greater than the first voltage difference Vt1.

According to an exemplary embodiment, a coupling phenomenon between a driving touch voltage and a voltage may be reduced. As a result, the overall luminance of a display device may be improved.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A display device comprising:
a display panel comprising pixels, each of the pixels comprising a display element, the display element comprising:
a first electrode configured to receive a first voltage;
a second electrode disposed on the first electrode, the second electrode configured to receive a second voltage, the second voltage being lower than the first voltage; and
a light control layer disposed between the first and second electrodes; and
a touch panel disposed on the display panel, the touch panel comprising:
a first touch electrode group; and
a second touch electrode group disposed crossing the first touch electrode group, each of the first touch electrode group and the second touch electrode group comprising a plurality of touch electrodes,
wherein one of the first touch electrode group and the second touch electrode group is configured to receive a scan signal having a first driving voltage level and a second driving voltage level; and
wherein the second voltage has a voltage value substantially between the first driving voltage level and the second driving voltage level.

2. The display device of claim 1, wherein a value of the second voltage is an average value of the first driving voltage level and the second driving voltage level.

3. The display device of claim 2, wherein the scan signal is formed of a first time interval having the first driving voltage level and a second time interval having the second driving voltage level, and
wherein a length of the first time interval and the second time interval is different.

4. The display device of claim 3, wherein the second time interval is longer than the first time interval.

5. The display device of claim 1, wherein the scan signal is formed of a first time interval having the first driving voltage level and a second time interval having the second driving voltage level, and
wherein a length of the first time interval and the second time interval is substantially identical.

6. The display device of claim 5, wherein a first voltage difference between the second voltage and the first driving voltage level and a second voltage difference between the second voltage and the second driving voltage level are different.

7. The display device of claim 6, wherein the second voltage difference is greater than the first voltage difference.

8. The display device of claim 6, wherein the first driving voltage level has a positive polarity and the second driving voltage level has a negative polarity.

9. The display device of claim 1, wherein one of the first touch electrode group and the second touch electrode group is configured to sequentially transmit the scan signal to corresponding touch electrodes.

10. The display device of claim 1, wherein the first electrode comprises an anode electrode, the second electrode comprises a cathode electrode, and the light control layer comprises an organic light emitting layer.

11. The display device of claim 1, wherein the first electrode comprises a pixel electrode, the second electrode comprises a common electrode, and the light control layer comprises a liquid crystal layer.

12. The display device of claim 1, wherein each of the first voltage and the second voltage have a Direct Current (DC) component.

13. The display device of claim 1, wherein the first voltage has a positive polarity and the second voltage has a negative polarity.

14. The display device of claim 1, wherein the touch panel is directly patterned on the display panel.

15. The display device of claim 1, further comprising a first Optically Clear Adhesive (OCA) film disposed between the touch panel and the display panel,
wherein the first OCA film is configured to couple the touch panel and the display panel to each other.

16. The display device of claim 15, further comprising:
a window member disposed on the touch panel; and
a second OCA film disposed between the touch panel and the window member,
wherein the second OCA film is configured to couple the touch panel and the window member to each other.

17. The display device of claim 1, wherein the display panel and the touch panel are flexible.

18. The display device of claim 1, further comprising a window member disposed on the touch panel.
